(19) United States
(12) Patent Application Publication
(10) Pub. No.: US 2011/0209382 A1
(43) Pub. Date: Sep. 1, 2011

(54) SYSTEM TO CATCH FISH AND THE RESPECTIVE METHOD OF USE

(76) Inventors: Claudia Sofia Da Silva Correia, Barcarena (PT); Mariana De Andrade Oliveira Henriques Duarte, Coruche (PT); Tiago Manuel Lourenco De Almeida, Oliveira Do Hospital (PT); João Pedro Santos Correia, Lisboa (PT); Miguel Hugo Vasco Galegos, Peniche (PT)

(21) Appl. No.: 13/000,808

(22) PCT Filed: Jun. 22, 2009
(86) PCT No.: PCT/IB2009/052673

§ 371 Date: May 5, 2011

(30) Foreign Application Priority Data
Jun. 23, 2008 (PT) 104107

(51) Int. Cl. A01K 79/00; A01K 99/00

(52) U.S. Cl. 43/4.5; 43/4

(57) ABSTRACT

The disclosed subject matter concerns a system and related method that forms a wall of bubbles, which is used to catch fish. The system consists of or can include, at least, two boats, two or more chambers, a suction pump, a compressor and a device that forms a wall of bubbles, constituted by one or more bubble making chambers, one or more conducting chambers, conducting tubes, floating tubes and ballast, which, by forming a “net” of bubbles, enables fish to be trapped and subsequently caught. Thus, the disclosed subject matter is useful for catching fish in a more economical and ecological manner, eliminating conventional nets and reducing the level of non-target species being caught. Another advantage is an improvement in the quality of the catch. This system can be used in the fishing industry and in aquaculture.

### TECHNICAL AREA OF THE INVENTION

This invention represents a system used to catch fish, which allows schools of fish to be surrounded by forming a wall of bubbles. The schools are then caught by means of a suction pump. Thus, this invention can be used in the fisheries sector, namely as a substitute for fishing with conventional seine nets.

### ANTECEDENTS OF THE INVENTION

Document No. JP2000236778 (Method of gathering fish, NANBA KUNIO) describes the use of a set of submarine robots, which, arranged in a circle at the bottom of the sea, send out bubbles that form a cylindrical “net” surrounding the fish, thus allowing them to be caught with a conventional net. In the case of this present invention the fish are captured by means of a suction pump and not a conventional net. Moreover, this invention does not envisage the use of robots, but instead uses a device with a chamber, to form a “net” of bubbles, and another chamber to control floating, thus ensuring that the “net” of bubbles is dynamic (its depth can be controlled) while in the said document it is static (the robots remain on the seabed).

Document No. U.S. Pat. No. 4,788,928 (Pneumatic plunger system, TAUBER DAVID, PHILIPPSON WILLIAM) describes a set of nozzles located along the keel of a boat, which expel a mixture of air bubbles and water, downwards, thus creating a vertical wall of bubbles. This repels the fish towards the net which is stretched out in the sea from one of the sides of the boat. This present invention differs from the subject of the aforesaid document insofar as it uses a closed “net” of bubbles and not an open net to catch fish, and uses a suction pump and not a conventional net, thus eliminating the use of a conventional net to surround the fish.

Document No. US2006174839 (Fish herding or guidance tool, ELY RICHARD D) describes an apparatus to attract and herd fish through the water, using a set of tubes that release air bubbles, producing a wall of air bubbles that attracts fish owing to its visual patterns. Apart from being a different system comprising various elements, the present invention also has a different objective with regard to the subject of the aforesaid document, since it does not aim to attract fish by means of visual patterns, but instead seeks to catch them. Unlike the contents of the aforesaid document, this invention constitutes a fishing “net” and includes a suction pump to catch fish.

The first document pertains to a static mechanism, which does not allow accompanying the movement of the school of fish in the water column. It is a more complex and expensive technology, both at the time of acquisition as well as in cases of malfunctions or the loss of the mechanism. The fact that it utilises conventional nets to capture the fish is a disadvantage in terms of the quality of the catch.

The system described in the second document only prevents fish from fleeing from under the boat while the seine nets are being manoeuvred. It entails profound changes to the hull of the ship or even the construction of a new and totally modified boat. The bubbles are projected against gravity, implying a greater pressure and the consequent consumption of energy to form the wall of bubbles. The fish are still caught by using traditional fishing nets. Therefore, problems in terms of ecological issues, the quality of the fish caught and the profitability of the catch level still remain unresolved.

The third document only presents a technology that is capable of attracting fish, without being able to control the depth or being able to catch fish.

The main advantages derived from the use of the system of this present invention, as compared to the various existing methodologies to catch fish, are the fact that it uses a suction pump, a device with a chamber that forms a “net” of bubbles and another device that controls floatability, thus dynamising the entire process. These facts make it possible to control the depth and the speed at which the device rises and descends. The fact that the “net” of bubbles is closed and not open makes it possible to maximise the catch and prevent fish from fleeing.

### GENERAL DESCRIPTION OF THE INVENTION

This invention represents a system that enables schools of fish to be trapped and caught. It is constituted by, at least, two boats, two or more chambers, a suction pump, a compressor and a device that forms a wall of bubbles, comprising a chamber that forms bubbles, conducting tubes, floating tubes and ballast, which trap fish by forming a net of bubbles.

1. System to Catch Fish

The system of this invention comprises at least two boats. One of the boats must be at least medium sized (15), while the other(s) can be smaller (16), so that it (they) can be transported by the larger boat. The smaller boat(s) will be responsible for manoeuvring and releasing the device around the school of fish.

The larger boat should be a motorised boat habitually used for coastal fishing, with a cabin, or of the kind used for fishing off the coast. It should have an external length of more than 9 metres. The type of fishing is identical to the seine style of fishing (with daily tides and relatively close to the coast). This boat should at least have the capacity to carry the compressor (8), with a pressure higher than 5 bar, electric or diesel, i.e. it should have at least 10 m² of space available, and a suction pump (17) connected to the hold of the boat, which can separate fish according to the minimum legal size allowed while expelling the water which has been sucked up. The hold must be adapted to handle and separate the catch. The deck of the boat must also be able to support a reel to store the bubble forming device (7) and space to transport the smaller boat(s) (16).

In co-operation with the larger boat, the smaller boats serve to place the device around the school of fish, enclosing it. These smaller boats should be motorised and have a minimum capacity of being able to transport at least one person. At one of the ends of the boat(s) there will be a cable that links the device (7) to the boat. This is the guide for the system, which remains perpendicular to the surface and is longer than 10 metres.

The suction pump (17) consists of, at least, one tank, preferably two, working on the basis of a vacuum, so that one of the tanks can catch the fish while the other creates a vacuum and vice-versa, maximising the profitability of the catch. This suction makes it possible to suck up the fish along with the water, alternating between the tanks, so as to channel the fish to the boat's hold. Once in the hold, fish with commercial value will be separated from the water and from smaller fish, which will be returned to the sea. This separation is done by means of a conveyor belt with a sieve, which allows fish to be selected according to their size. The capacity of the suction pump varies according to the quantity and the size of the fish that are to be caught, i.e. it must be capable of sucking up at least the quantity of fish habitually caught by using a traditional seine net. For example, between 20 kg and 1 ton of fish per casting of the net.

One of the functions of the suction pump (17) is to ensure selection with regard to the minimum legal sizes allowed for catches. The law stipulates a minimum size for each target species which can be caught. This minimum size is stipulated by the entities responsible for the fishing zone in which the boats are carrying out their fishing activities. Thus, the suction pump must have the capacity to catch the fish in the best possible conditions, and to separate the catch according to size by means of a net or sieve. The fish which have been caught that are smaller than the allowed size will be put back to sea again along with the water that has been sucked up.

As an example, the following table lists some species and the corresponding minimum dimensions allowed by Portuguese legislation for fish being caught (Table I).

TABLE I
Target species for seine catches in Portugal
[adapted from: www.dgpescas.pt].

| | | Minimum size |
|---|---|---|
| Commercial name | Scientific name | (cm) |
| Sardine | Sardina pilchardus | 11 |
| Atlantic horse | Trachurus | |
| mackerel/Blue | trachurus/Trachurus | 15/14 |
| jack mackerel | picturatus | |
| Atlantic | Scomber scombrus | 15 |
| Mackerel | | |
| Chub mackerel | Scomber japonicus | 15 |
| Pout | Trisopterus luscus | 17 |
| Anchovy | Engraulius encrasicolus | 12 |
| Seabream | Pagellus acarne | 18 |

For example, in the case of sardines, where the minimum legal size for caught fish is 11 cm, the sieve selecting the fish according to size must be able to return sardines that are 11 cm in size or smaller to the sea, along with the water, retaining fish that are larger.

According to this present invention, the compressor (8) has the capacity to maintain the supply of air to form the bubbles without the air that is expelled being toxic to the environment. Thus, for this purpose the pressure will have to be more than 5 bars and the ideal pressure is higher than 10 bars. The compressor can be either electric or diesel. The choice of the compressor will vary according to the size and spacing of the holes, so that all these mechanisms together maintain the sustainability and thickness of the wall of bubbles. The capacity of the compressor must be directly proportional to the length of the device and the size of the holes. The single (4.1) or double (4.1 and 4.2) intake of air to the upper chamber also influences the choice of compressor, as a dual intake is less taxing for the compressor.

The system of this invention also includes a set of elements to form bubbles—a bubble making device (7)—constituted by one or more bubble making chambers (2), conducting tubes (4), between 1 and 2000 floating tubes (5), between 1 and 10 and at least one ballast (6). This set of elements defines segmented areas and each of these segments consists of two or more chambers, upper chambers and lower chambers. The size of each segment varies according to the size of the intended enclosure and according to the target species and can range from 1 m to 1000 m.

The coupled chambers (2 and 3) serve to form a wall (net) of bubbles and to control the position of the system in the water column. Thus, one of the chambers must be positioned at a higher level (2) so as to project the bubbles vertically, since the system will move downwards. Another chamber must be at a lower level (3) so that the ballast system and the system to control the floatability do not interfere with the bubble forming chamber.

The upper chambers are responsible for conducting air through the holes in each segment. The intake of air in the upper chambers (2) can be done either through one (4.1), or both sides (4.1 and 4.2), according to the target species and the need to have a greater thickness for the wall of bubbles (14). A single connection (4.1), on just one side, obliges the air to run through the entire chamber, so that the air reaches all the holes, thus achieving a wall that is less thick as compared to the double intake (4.1 and 4.2). When the air enters through both sides of the chamber, it tends to clash in the middle of the chamber, thus resulting in a thicker and more consistent wall. This is ideal for more aggressive target species or during adverse conditions at sea (e.g. depth currents).

The upper chamber (2) has holes (1) through which the air that will form the wall of bubbles exits. These holes are sized to ensure the sustainability and density of the wall of bubbles so as to prevent the fish from escaping. To this end, the holes vary in size from 1 micron (μm) to 20 centimetres (cm), but are preferably sized between 1 mm and 2 cm, with a spacing that can range from 1 micron to 50 metres, but is preferably spaced between 5 mm and 50 cm. All these parameters vary according to the depth, the depth currents, the target species, the type of compressor being used and the number of ships involved.

The lower chambers (3) bring together devices that are essential for the system's functioning, such as, for example, at least two floating tubes (5); (4), an equal number of conducting tubes as the upper chambers, in the case of a single intake (4.1) or twice as many in the case of a double intake (4.1 and 4.2); and at least one ballast (6). The lower chambers bring together all the devices along the system so that the system functions, i.e. they bring together the floating tubes and the ballast, which make it possible to control floatability, and the conducting tubes which are responsible for conducting air to each upper chamber (at least one conducting tube per upper chamber).

The conducting tubes (4) are formed by hoses with compressed air and are responsible for transporting air to all the upper chambers of the various segments of the bubble forming apparatus. The number of conducting tubes varies according to the necessary segments and according to the input of air necessary for each segment, so as to form a greater thickness, as a single intake (4.1) or double intake (4.1 and 4.2), i.e. for a less consistent thickness a single intake is used and for a more consistent thickness a double intake is used. In other words, the intake of air can be achieved in just one direction or in both directions. The material used has to be able to resist great pressure and have some flexibility, such as, for example, air pressure hoses made of PVC or other similar materials.

The floating tubes are made of a material that is very flexible and has the capacity to expand, for example a canvas hose. It is continuous throughout the device and the respective opening(s) are always on one of the larger boats, so as to enable control over the entry/exit of water and the entry/exit of air and to allow the entire device to sink or float, according to the stage and the needs of the procedures to catch the fish. This aspect makes it possible to control the rise/descent of the device in the water column. This mechanism is based on the functioning of the ballast tanks of submarines and ships, so as to control floating according to the cargo being transported.

The ballast (6) and the floating tube (5) serve to control floatability in the water column. The ballast, made of a material that is denser than the water, adds weight to the bubble making apparatus, with a view to providing stability to the entire mechanism. Examples of the materials which can be used for the ballast include lead and cement.

Each section of the bubble forming device (7) has an independent air feed through the conducting tubes (4). This segmentation is important in order to ensure that the air leaving through the holes (1) has sufficient pressure to ensure the sustainability of the wall of bubbles. This factor is also important while manoeuvring the device after the wall of bubbles is formed, since it makes it possible, by trapping the fish inside the wall of bubbles and reducing the diameter of the enclosure created by the device, to disconnect the segments that are no longer effectively trapping the school of fish. This results in a greater availability of the air from the compressor for the segments that are operational.

2. Method to Catch Fish

The bubble forming device (7) is cast by the smaller boats (16) so as to surround the school of fish. In order to ensure that the fish do not escape while the device is descending, it should allow a sufficient excess margin while enclosing the school of fish.

Subsequently, the floating tube (5) is filled with water to ensure that the device sinks deeper than the school of fish. Once the device is between 5 and 20 metres below the school of fish, it is stabilised by balancing the air/water equilibrium inside the floating tube (neutral float). At this point the air supply for the diffusing chamber (2) is switched on, to form the bubbles (14) which will allow the fish to be trapped. As the diameter of the area enclosed by the wall of bubbles progressively reduces, causing the fish to rise in the water column, the floating tube (5) is filled with air, so that the device (7) is preferably between 5 and 20 metres below the school of fish. As soon as the fish are at the desired depth, they can be caught by using at least one suction pump (17).

The depth and the speed at which the device (7) rises/descends are controlled according to the position of the school of fish with regard to the surface and are enabled by means of the floating tube (5). This factor allows greater manoeuvring control for the entire fishing operation. The fish are monitored by means of traditional equipment on the boat (sonar, radar, amongst others). As soon as the fish move deeper, the floating tube is filled with water so as to ensure that the device maintains a depth of between 5 and 20 metres below the school of fish.

Neutral floating is achieved by means of an equilibrium between the ballast (6) and the floating tube (5), joined with the conducting chamber (or lower chamber) (3), and the pressure inherent to the depth at which the device (7) is situated, allowing the device to descend, by the entry of water and the expulsion of air, and to rise, by the entry of air and the expulsion of water.

The absence of conventional fishing nets in the system of this present invention represents a great advantage at diverse levels, such as a solution for one of the greatest problems faced by this sector i.e. selectivity while catching target species, thus reducing accessory catches, i.e. catching non-target species, whether endangered or not.

Moreover, in case the device (7) is lost it does not represent a threat to the eco-system, since in case this happens the device sinks immediately and therefore does not constitute a phantom seine, i.e. after being lost the device can no longer catch fish or cause great damage to the environment. This is in stark contrast to conventional nets which, when lost, capture species indiscriminately until they become sufficiently heavy so as to sink to the seabed (this can take several months and kill hundreds of species).

In terms of the quality of the catch, this invention ensures a significant improvement with regard to quality, since it does not involve the hauling manoeuvre of conventional nets, a process that is very abrasive for the fish and which causes considerable damage to the catch. Thus, with the system of this present invention, the fish are collected by means of a suction pump (17), eliminating the aggressive contact of manoeuvres with conventional nets.

The absence of human handling results in a significant improvement in the quality and freshness of the fish. Since the fish are captured at sea and go directly to the hold of the fishing boats (15), the loss of scales is minimised, death is quicker, causing less stress for the fish, which also improves the quality of the fish flesh.

The cost associated with using the present invention is less than acquiring and maintaining nets. Likewise, the fact that it is a segmented apparatus is also an economic advantage, since boats do not need to pause for repairs while fishing, as is the case in current techniques, when it is necessary to repair a net manually. They only need to substitute the damaged segment. The system can thus be repaired in sections, merely substituting the section which has been damaged or lost.

The system of this invention occupies relatively little space on board the boat, when compared to diverse other existing techniques, given the space occupied by nets. This device is stored rolled around a drum which is located on the deck of the boat (15), which in a traditional seine technique only rolls the master line of the net. This drum is capable of rolling up to 1500 metres of the device.

All these aspects represent advantages, both at an ecological as well as at an economic level, thus presenting very significant ecological savings

This invention also solves the problem that the use of conventional nets constitutes for the marine ecology and for the quality of the catch, apart from the high acquisition and maintenance costs conventional nets represent. It thus offers advantages while substituting seine fishing.

### DESCRIPTION OF THE FIGURES

FIG. 1: Schematic representation of the system of the present invention, forming the wall of bubbles, a section viewed from above. The figure shows the holes (1) that form the wall of bubbles, the upper chamber (2), the lower chamber (3), the conducting tubes (4), the floating tubes (5), the ballast (6) and the bubble making device (7).

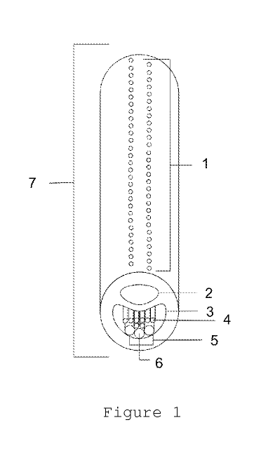

FIG. 2: Schematic representation of the link between the compressor and the system of this invention. It shows the holes (1), the upper chamber (2), the lower chamber (3), the conducting tubes (4), the floating tubes (5), the ballast (6), the bubble making device (7), the compressor (8), the taps for regulating the air to each section and to the floating tube (9), the water pump for the floating tube (10), the tap to regulate the entry of water (11) and the tap to regulate the removal of the water (12).

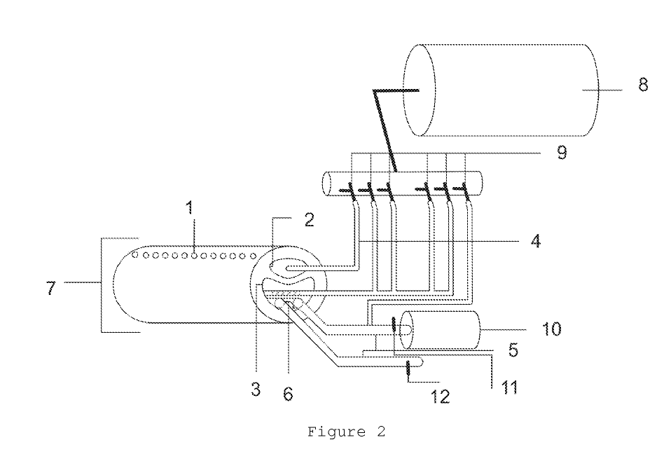

FIG. 3: Schematic representation of the connection between two sections of the system of this invention. It shows the holes (1), the upper chamber (2), the lower chamber (3), the conducting tubes (4), with a single input (4.1) or double input (4.1 and 4.2), for each section, the floating tubes (5), the ballast (6), the bubble making device (7), the conducting tube for the section (4.1 or 18) and a junction (13) between two sections.

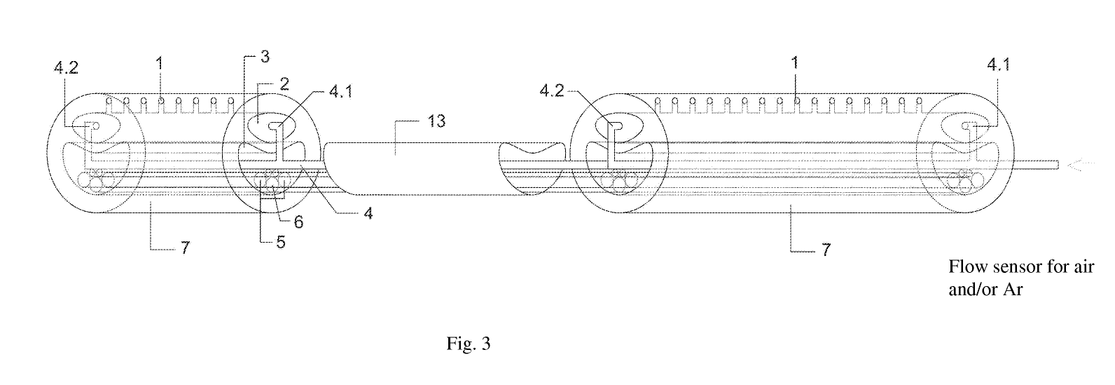

FIG. 4: Schematic representation of the system of the invention in operation, at two moments: the wall of bubbles beginning to be formed (4a) and the catch by means of the suction pump (4b). It shows the bubble making device (7), the compressor (8), the wall of bubbles (14), the main boat (15), the secondary boat (16) (generally a skiff) and the suction pump (17).

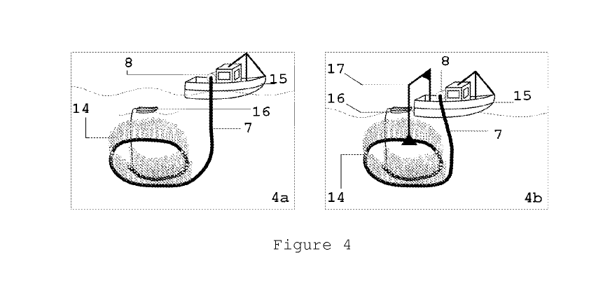

### DETAILED DESCRIPTION OF THE INVENTION

### 1. System to Catch Fish

The system of this invention is constituted by:
a) At least two boats (15) (16);
b) A suction pump (17) with chambers/tanks into which to suck the caught fish;
c) A compressor (8); and
d) A device to form a wall of bubbles (7), constituted by:
   d.1) One or more bubble forming chambers, an upper or diffusing chamber (2), a lower or conducting chamber (3);
   d.2) Conducting tubes (4);
   d.3) Floating tubes (5); and
   d.4) Ballast (6)

The system of this present invention can be divided into segments, each of which comprises:
An upper or diffusing chamber (2);
A lower or conducting chamber (3):
Conducting tubes (4);
Floating tubes (5);
Ballast (6).

### 2. Method to Catch Fish

All the equipment is located on the larger boat (15).

The smaller boat(s) (16) has (have) one end of the device and is (are) responsible for arranging it around the school of fish, surrounding it completely, in co-operation with the larger boat. The device is released in the water and placed preferably in a spiral, which can be in a circular form. This arrangement of the equipment is due to the way in which the diameter of the enclosure is reduced with regard to the school of fish, which facilitates the process of catching the fish.

The floating tube (5) is then filled with water until it reaches about 5 to 20 metres below the school of fish. At this point the device is stabilised, by balancing the air/water inside the floating tube (neutral floating).

Subsequently, the air to the upper or diffusing chamber (2) is switched on, to form the bubbles (14) that will allow the fish to be trapped.

As the diameter of the enclosure formed by the wall of bubbles (14) progressively reduces, causing the fish to rise in the water column, the floating tube (5) is filled with air, thus enabling the bubble making device to rise in the water column, obliging the fish to rise in a similar fashion, facilitating the catch.

After being surrounded by the bubble making device (7), the fish are then caught by means of a suction pump (17) which takes fish of commercial interest to the hold while smaller fish are rejected directly to the sea along with the water being sucked out.

### EXAMPLES

This present invention is aimed, preferably, at the fishing industry. It functions ideally on a mid-sized boat, assisted by a smaller boat, such as, for example, a skiff. A two-chambered suction pump is installed on the medium sized boat along with a compressor with an air output of about 25 m³/12 bar.

The bubble forming apparatus consists of 8 sections, of 100 metres each.

The air output holes are 1 mm wide and spaced around 2 cm apart.

For a school of fish located at around 10/15 metres, the device is released so as to achieve a depth of 25 metres with a diameter of about 160/180 metres, and it is released in the form of a spiral. It is then stabilised with the help of the floating tube.

After the bubble forming device has been stabilised, the air is connected to all the sections at the same time. As soon as the air is switched on, the suction pump is readied to start working.

With the assistance of both boats the operator then begins to reduce the diameter of the spiral formed by the apparatus, so as to confine the fish to a smaller area, adjusting the depth of the apparatus according to the depth of the school of fish. The bubble forming apparatus should never be higher than the school of fish.

As soon as the school of fish is confined to the smallest possible area, the extraction of the fish is begun with the suction pump. This process is undertaken as quickly as possible to prevent the fish from escaping.
Lisbon, 23 Jun. 2008

1. System for capturing fish comprising at least two vessels, two or more cameras, a suction pump connected to the bilge of the main vessel for storing the captured fish, an electrical or diesel air-pump, with a pressure higher than 5 bar, and a device forming a wall of bubbles, comprising one or more cameras forming bubbles, conductive channels, floating channels and a ballast.

2. System for capturing fish according to claim 1, wherein the device forming the wall of the bubbles comprises segments which are independent but simultaneously interconnected to each other, the segments consisting of an upper camera or diffusing camera which directs air into the holes of the said camera, an inferior or conductive camera that directs air along segments, conductive channels and floating channels, each independent segment having an air feeding device that supplies air into the conductive channels by means of the air-pump connection, the channels having single or double inlets and having independent, individual and controllable floatations.

3. System for capturing fish according to claim 2, wherein the inferior or conductive camera combines devices responsible for buoyancy, such as the ballast, by means of the dense material providing it with the desired stability and density, floating channels, by means of water and air inlet and outlet thereof, and further comprising conductive channels directing the air into each section.

4. System for capturing fish according to claim 3, wherein devices responsible for buoyancy are combined within the inferior or conductive camera, the devices being characterized by the ballast, which allows the device to acquire negative buoyancy and submerge within the water column, and by the floating channels, which allow the device to either acquire negative buoyancy and therefore submerge within the water column or acquire positive buoyancy and therefore emerge from the water column through the water inlet/outlet and air inlet/outlet, respectively.

5. Method for capturing fish wherein:
a) With the aid of larger vessels, smaller vessels surround the shoal, enclosing it and placing the device in a circular or spiraled manner, so as to reduce the enclosing area of the shoal;
b) The floating channel is subsequently filled with water such that the device obtains greater depth in relation to the shoal, of about 5 to 20 m;
c) The air in the upper or diffusing camera is then actuated for bubble formation, the bubbles allowing the imprisonment of the fish;
d) as the siege formed by the wall of bubbles is reduced in diameter, the floating channel is filled with air, forcing the device and the fish to ascend along the water column;
e) The capture of the fish is subsequently carried out by means of the suction pump, which is connected to the bilge of the main vessel.

6. Use of the system for capturing fish according to claim 1, wherein the system is used in fishing industry as substitute for conventional fishing-net besieging, frames for directing the fish and applications in aquaculture, subdivision of tanks, by means of the use of the wall of bubbles for separating individuals and capturing fish in tanks.

7. Use of the system for capturing fish according to claim 2, wherein the system is used in fishing industry as substitute for conventional fishing-net besieging, frames for directing the fish and applications in aquaculture, subdivision of tanks, by means of the use of the wall of bubbles for separating individuals and capturing fish in tanks.

8. Use of the system for capturing fish according to claim 3, wherein the system is used in fishing industry as substitute for conventional fishing-net besieging, frames for directing the fish and applications in aquaculture, subdivision of tanks, by means of the use of the wall of bubbles for separating individuals and capturing fish in tanks.

9. Use of the system for capturing fish according to claim 4, wherein the system is used in fishing industry as substitute for conventional fishing-net besieging, frames for directing the fish and applications in aquaculture, subdivision of tanks, by means of the use of the wall of bubbles for separating individuals and capturing fish in tanks.
